(19) United States
(12) Patent Application Publication
(10) Pub. No.: US 2017/0228034 A1
(43) Pub. Date: Aug. 10, 2017

(54) METHOD AND APPARATUS FOR PROVIDING INTERACTIVE CONTENT

(71) Applicant: THOMSON LICENSING, Issy les Moulineaux (FR)

(72) Inventor: Jeffery Dale HOLLAR, Livermore, CA (US)

(21) Appl. No.: 15/514,526

(22) PCT Filed: Sep. 11, 2015
(86) PCT No.: PCT/US2015/049706

§ 371 Date: Mar. 26, 2017

Related U.S. Application Data
(60) Provisional application No. 62/055,998, filed on Sep. 26, 2014.

(51) Int. Cl. G06F 3/01; G06F 3/14

(52) U.S. Cl. CPC G06F 3/017; G06F 3/1423; H04N 21/812

(57) ABSTRACT

Ways to provide interactive media content are described. Interactive displays (110) may include a sensing element (130) that is able to sense user movements in order to collect motion data. Such collected data may be used by the display (110) or a server (160) to identify gestures. Such gestures may be used to control the presentation of the media content. A first display (110) may receive a gesture command and send a message to a server (160) based on the received command. The server may, in turn, select updated content based on the message. The server may send the updated content and/or associated information to the first display (110) and/or other displays associated with the first display. The updated content may be used by each display until some termination criteria is met, at which point the displays may revert to the original content.

### BACKGROUND

Retailers use in-store advertising to help influence consumer behavior and promote purchases. Current advertising arrangements use non-attentive video presentations. Such video presentations presume that consumers will be attracted to the video presentation without being able to determine whether or not the consumer is actually watching or engaged with the information provided in the video presentation.

Current solutions may allow selection of media but require use of touchscreens supporting multi-touch gestures, or whole body image tracking systems based on the use of web cameras.

Multi-touch systems are prone to many issues which can prevent a touch screen from functioning properly. For example, over time the calibration of the touch screen sensing components must be reset. The constant touching of the screen increases the chances of scratching, dirt and grease obscuring the display and/or a screen being damaged. A touch screen is also restricted to locations in close proximity allowing user contact.

Image tracking systems based on web cameras generally track whole-body gestures using an infrared projector and camera to track the movement of objects and individuals in three dimensions. Such a solution requires a large space within which to make whole-body movements.

Thus there is the need for an interactive display that is reliable, is able to be implemented in a small space, and does not require that users have physical contact with the display.

### BRIEF SUMMARY

Some embodiments allow consumers to interact with advertising presented via a display. Some embodiments may include motion sensing elements that are able to detect user movements such as hand gestures. Such motion sensing elements may be able to generate commands that at least partly control the operations of the display.

Using gestures, a consumer may at least partly control the presentation and thus receive information that is of interest to the consumer. A user may be able to navigate to different content (e.g., a next clip in a playlist) and/or interact with currently provided content (e.g., by making a selection to display additional product information, receive a special offer related to the product, etc.). In some embodiments, such user interactions may be monitored and/or data may be collected for analysis.

In addition, some embodiments may allow an administrator user to use gestures to update content to be displayed to consumers. Such updates may be applied to multiple displays, as appropriate. In this way, an administrator may easily evaluate changes by viewing content on an actual display before applying the changes to a group of displays.

The preceding Brief Summary is intended to serve as a brief introduction to various features of some exemplary embodiments. Other embodiments may be implemented in other specific forms without departing from the scope of the disclosure. The Detailed Description that follows and the Drawings (or “Figures” or “FIGS.”) that are referred to in the Detailed Description will further describe some of the embodiments described in the Summary as well as other embodiments. Accordingly, to understand all the embodiments described by this document, a full review of the Summary, Detailed Description and the Drawings is needed.

### BRIEF DESCRIPTION OF THE SEVERAL VIEWS OF THE DRAWINGS

The novel features of the disclosure are set forth in the appended claims. However, for purpose of explanation, several embodiments are illustrated in the following drawings.

FIG. 1 illustrates a schematic block diagram of an interactive display system according to an exemplary embodiment;

FIG. 2 illustrates a schematic block diagram of an establishment system of some embodiments that uses a set of interactive displays of FIG. 1;

FIG. 3 illustrates a schematic block diagram of a multi-establishment system of some embodiments;

FIG. 4 illustrates a flow chart of a conceptual client-side process used by some embodiments to provide an interactive consumer experience using a stand-alone interactive display;

FIG. 5 illustrates a flow chart of a conceptual client-side process used by some embodiments to provide an interactive consumer experience using a network-connected interactive display;

FIG. 6 illustrates a flow chart of a conceptual client-side process used by some embodiments to provide administrative features using an interactive display;

FIG. 7 illustrates a flow chart of a conceptual client-side process used by some embodiments to provide administrative features using a network-connected interactive display;

FIG. 8 illustrates a flow chart of a conceptual server-side process used by some embodiments to provide media to a set of interactive displays;

FIG. 9 illustrates a schematic block diagram of a communication procedure used by some embodiments to provide an interactive experience; and

FIG. 10 illustrates a schematic block diagram of a conceptual computer system used to implement some embodiments.

### DETAILED DESCRIPTION

The following detailed description is of the best currently contemplated modes of carrying out some exemplary embodiments. The description is not to be taken in a limiting sense, but is made merely for the purpose of illustrating the general principles of the disclosure, as the scope of the disclosure is best defined by the appended claims.

Various inventive features are described below that can each be used independently of one another or in combination with other features. Broadly, some embodiments generally provide ways to allow consumers to engage, using hand gestures, with media presented on an interactive display device. Some embodiments use motion sensing technology to detect hand movements that occur within a small hemispherical area. Those events may then be translated into the appropriate commands to control the media presentation.

A first exemplary embodiment provides a method adapted to provide interactive content. The method includes: presenting default media content at a first display; identifying an input gesture using a sensing element associated with the first display; sending, to a server, a message based at least partly on the input gesture; receiving, from the server, a reply comprising updates to the default media content; and presenting updated media content based at least partly on the reply.

A second exemplary embodiment provides an apparatus adapted to provide interactive media content. The apparatus includes: a first display adapted to present media content; a media player adapted to provide default media content to the first display and provide updated media content to the first display based at least partly on receipt of an update message including updates to the default media content; a motion sensing element adapted to capture input gestures within an input area associated with the first display; and a communication module adapted to send, to a server, a message based at least partly on a captured input gesture and receive, from the server, the update message.

A third exemplary embodiment provides a method adapted to provide content to a set of interactive displays. The method includes: providing media content to each interactive display in the set of interactive displays; monitoring each interactive display in the set of interactive displays; identifying a command received from a first interactive display in the set of interactive displays; updating the media content based at least partly on the command; and sending the updated media content to each interactive display in the set of interactive displays.

A fourth exemplary embodiment provides an apparatus adapted to provide interactive advertising content. The apparatus includes: a set of interactive displays, each interactive display adapted to identify gestures and generate commands based at least partly on the identified gestures; and a server adapted to provide default media content to each interactive display in the set of interactive displays, monitor each interactive display in the set of interactive displays, identify a command received from a first interactive display in the set of interactive displays, generate updated media content based at least partly on the command, and send the updated media content to each interactive display in the set of interactive displays.

Some embodiments allow retailers to create digital brochures. Such brochures, similarly to a traditional paper brochure, may be displayed throughout a retail location. Consumers may use, for example, swiping gestures to page through the brochure and/or tapping gestures to select items to display more information such as price and location of the item.

Retailers may utilize the presentation system of some embodiments to request consumer information. Some embodiments may be used to collect consumer input or feedback. For example, a display may be promoting a new product or service. The consumer may be able to use hand gestures to sign their name, enter contact information, select options, approve requests, etc.

Some embodiments are able to support new or existing video network systems without impact to current hardware configurations. The controller system may be placed anywhere near the display unit and may communicate with the display (e.g., via a Linux-based component).

The controller system may translate gesture events into commands recognized by the video network. In some embodiments, the gestures may be sensed using a combination of infrared elements (e.g., an array of light emitting diodes or “LEDs” and one or more cameras). Such an arrangement may allow motions within a hemispherical area of appropriate size (e.g., a radius of one meter) near the controller system to be precisely sensed. Such an input area may be presented using various signs or guide elements to indicate the size, shape and placement of the input area.

Sensed motions may include hand gestures within the input area to be captured. Such gestures may include gestures with movement (e.g., swipe right/left, point, tap, push, punch, raise hand, lower hand, wave hand, etc.) and/or stationary gestures (e.g., forming a fist, giving a thumbs-up or thumbs-down signal, extending one or more fingers, gestures associated with sign language, etc.).

The sensed motions may be translated to commands using a look-up table or other appropriate resource (e.g., a database of commands and associated motions). In some cases, the motions may be translated to commands at the controller system. Alternatively, captured movement may be sent directly to a video network system server for analysis (and/or to a display unit or other appropriate element). In some embodiments, the sensed motions may be compared to previously recorded motion data (e.g., to verify the identity of an administrative user). In some cases, a single command may be associated with multiple motions.

Once translated, each command may be sent to an appropriate resource within the video network system controlling the presentation of the media (e.g., a server, an interactive display associated with the controller, etc.). Connectivity between the gesturing system(s), networked displays, and/or other video network components (e.g., a server) may be provided by a private network to ensure security and stability.

Different embodiments may include various different motions and/or associated commands. In addition, the system of some embodiments may respond to different gestures (and/or commands) in different ways depending on the status of the system or display (e.g., different options may be available depending on the type of product being advertised, a left gesture may represent a rewind command when playing a video and a back command when browsing pictures, etc.).

Several more detailed embodiments are described in the sections below. Section I provides a conceptual description of system architectures used by some embodiment. Section II then describes methods of operation used by some embodiments. Next, Section III describes several example usage scenarios enabled by some embodiments. Lastly, Section IV describes a computer system which implements some of the embodiments.

### I. System Architecture

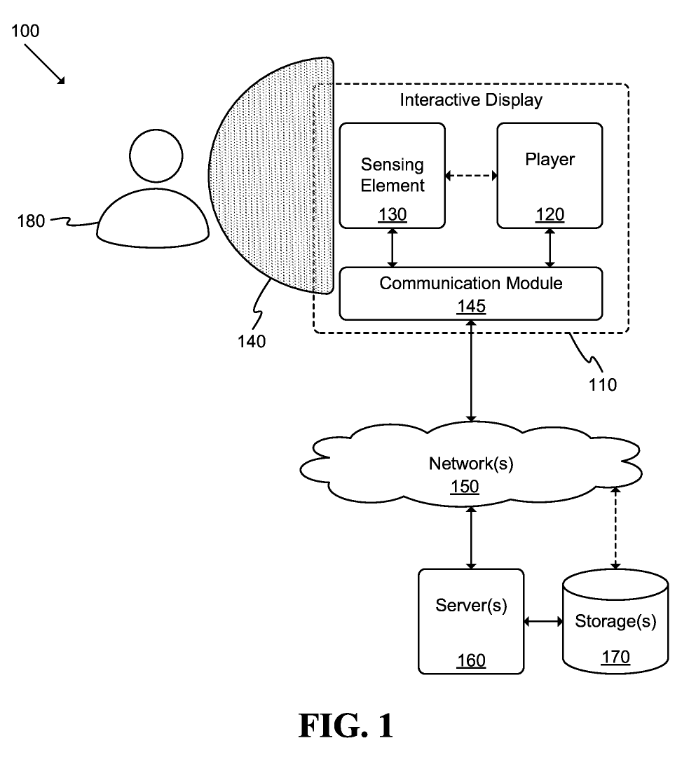

FIG. 1 illustrates a schematic block diagram of an interactive display system 100 according to an exemplary embodiment. As shown, the system may include an interactive display 110 having a player 120 and sensing element 130 with associated input range 140, one or more networks 150, one or more servers 160, and one or more storages 170.

The interactive display 110 may be implemented as a single unit that includes the player 120 and sensing element 130. Alternatively, the player 120 may be implemented using a first device and the sensing element 130 may be implemented using a second, separate device. In this way, the sensing element may be able to be placed at an appropriate location to receive inputs while the player 120 is able to be placed at an appropriate location for viewing by users 180. In addition, some embodiments may include multiple players 120 associated with a single sensing element 130, or multiple sensing elements associated with a single player 120.

The interactive display 110 may be an electronic device that is able to provide video content to a user 180. The display 110 may be an “end-cap display”, a shelf display, a free standing device, and/or any other appropriate implementation.

The player 120 may include a display, audio outputs (e.g., speakers), and/or other presentation elements. The player may be associated with a local storage (not shown) that provides media content to the player. In addition, the player may include a control element such as a processor (not shown) that may be able to receive inputs, process commands, instructions, and/or data, and/or otherwise be able to control the operation of the player.

The sensing element 130 may include one or more cameras or other appropriate sensing elements that are able to detect motion (e.g., infrared cameras combined with infrared LEDs). The input range 140 may be defined such that a set of input gestures is able to be detected at an appropriate location. The range may be a hemisphere in some embodiments. The input range may be configured such that the sensing element 130 is able to detect hand gestures. Different embodiments may be configured in different appropriate ways depending on the type of gestures to be captured. The sensing element may be able to communicate with the player 120, directly or over network 150.

Communication module 145 may allow the display 110 to communicate using network 150 (and/or other appropriate resources). The communication module 145 and/or any associated interfaces (not shown) may include various hardware elements able to communicate using defined protocols over various appropriate paths (e.g., network 150). In some embodiments, the player 120 and sensing element 130 may each be associated with a communication module such as module 145. In this way, a sensing element 130 at a first location may be able to sense motion and communicate captured data or identified commands to another appropriate system element (e.g., the player 120, a server 160, etc.). Likewise, a player 120 at a second location may be able to receive communications such as content updates, playback commands, etc. from various appropriate system elements (e.g., the sensing element 130, the server 160, etc.). In some embodiments, the player 120 and sensing element 130 may share a single communication module 145 that is able to send and/or receive communications sent among the player 120, sensing element 130, devices connected to network 150, etc.).

Network(s) 150 may allow the interactive display 110 (and/or sub-elements 120 and 130) to communicate with one or more servers 160 and/or storages 170. In this way, the interactive display 110 (and/or sub-elements 120 and 130) may be able to send commands or other information to the server 160 and/or storages 170 Likewise, the server 160 may be able to send commands or information to the display 110. Such networks 150 may include networks such as wired networks (e.g., Ethernet), wireless networks (e.g., Wi-Fi, Bluetooth, etc.), cellular networks, etc.

During operation, the display 110 may typically display content associated with a playlist or loop of clips. In addition to the content itself, such a loop may include attributes associated with various display options (e.g., time between clips, fade operations between clips, number of times to repeat a clip, etc.). Such a loop may be pre-defined by an administrator in various appropriate ways (e.g., via a server interface, using an interactive display of some embodiments, etc.).

As the loop plays, the sensing element 130 may monitor the input area 140. If a user 180 interacts with the sensing element 130 (e.g., by placing or moving a hand within the input area, by responding to a prompt such as “raise two fingers within the input area to receive more information”, etc.), the pre-defined or default media may be temporarily overridden by media associated with the sensed input. For instance, if a user indicates an interest in an advertised product (e.g., by forming a thumbs-up), the display 110 may provide more detailed information, location information within the store, special offers, etc. As another example, if a user indicates lack of interest (e.g., by swiping a hand), the player 120 may skip ahead to the next clip in the loop. After some reversion criteria is met (e.g., minimum time without user input, exhaustion of available content, user selection, administrative override, etc.) the display 110 may revert to the pre-defined playlist until another user event is identified.

In some cases, the input area 140 may be monitored to identify administrative or otherwise privileged users 180. When such a user is identified (e.g., via a pre-defined gesture password), a menu or other appropriate interface may be provided via the display 110 such that the user 180 may be able to override and update various settings. For instance, the user may be able to include different content, update loop or clip attributes, remove content, etc. Such updates may be able to be applied to multiple devices 110 (e.g., using server 160 and network 150).

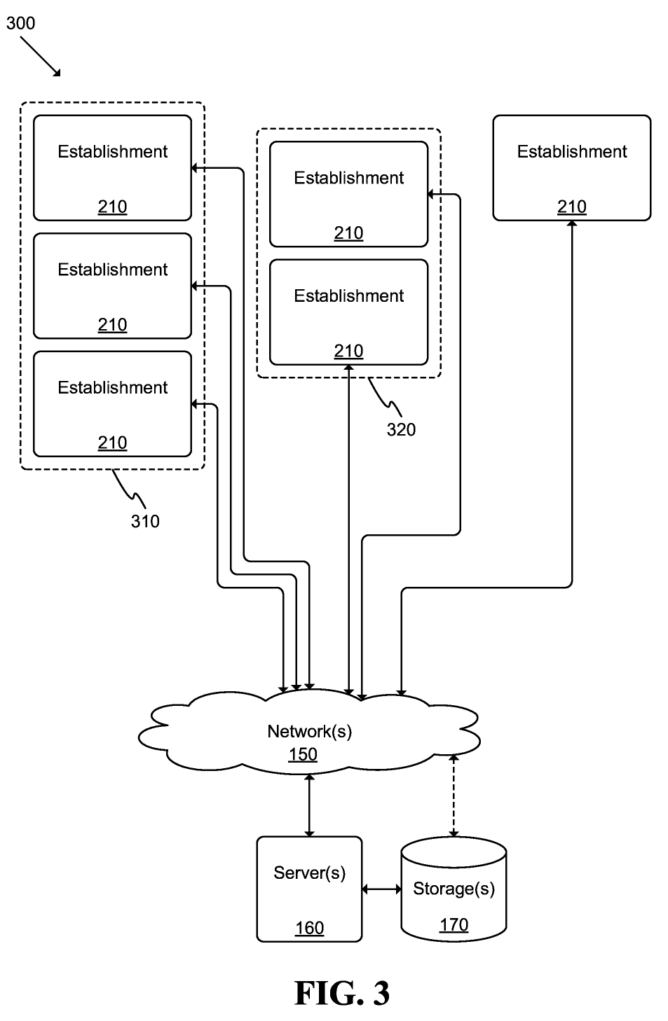

The operation of system 100 will be further described below in reference to FIGS. 3-9.

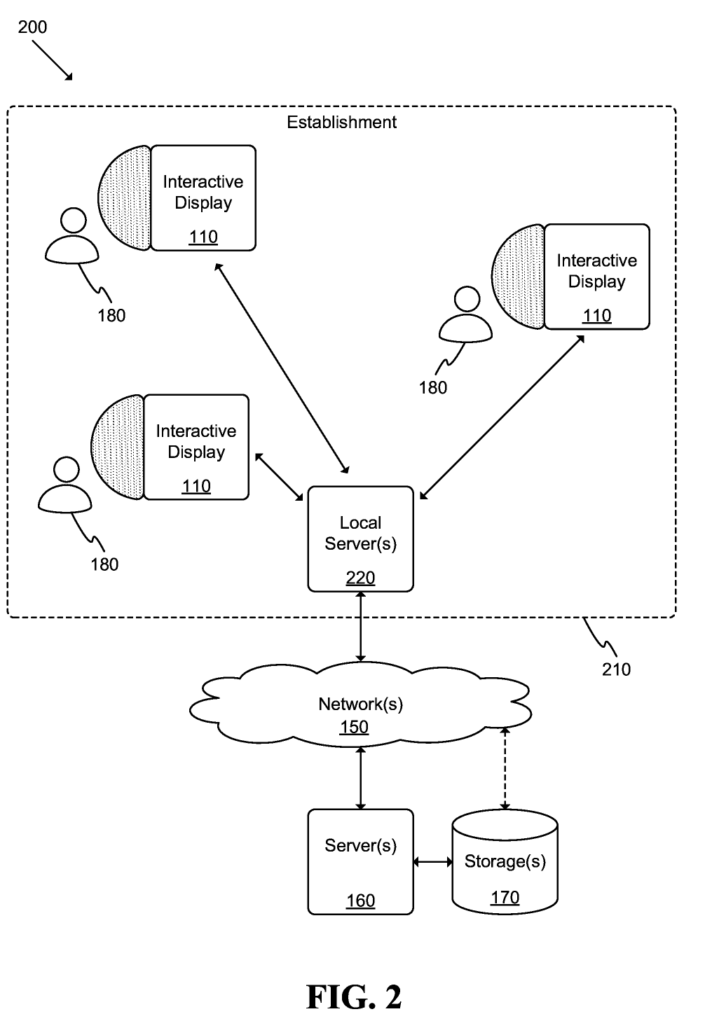

FIG. 2 illustrates a schematic block diagram of an establishment system 200 of some embodiments that uses a set of interactive displays 110. As shown, the system 200 may include a set of displays 110, a local server 220, one or more networks 150, one or more servers 160, and one or more storages 170.

An establishment 210 may represent a physical location or structure (e.g., a retail store) or section thereof (e.g., an area within a department store or grocery store). An establishment may also represent a virtual or online store. An establishment may also be a conceptual collection of displays 110 (e.g., a set of displays located at various retail establishments, where each display is associated with a manufacturer, brand, or product).

Some embodiments may include a local server 220 that is able to interact with the displays 110 associated with the establishment 210. Such a local server 220 may be able to access one or more local storages (not shown). In some embodiments, the interactive displays 110 may communicate with the local server 220 over a local network (not shown), with the local server providing a communication path from the displays 110 to the servers 160 and/or storages 170. In some embodiments, the displays 110 may be able to communicate directly over network 150 without using a local server 220.

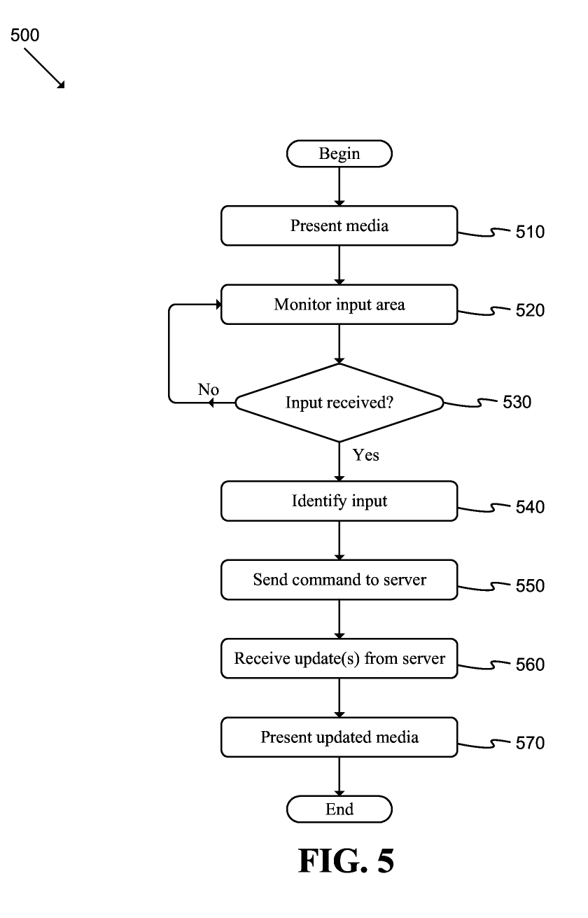

The operation of system 200 will be described below in reference to FIGS. 5 and 7-9.

FIG. 3 illustrates a schematic block diagram of a multi-establishment system 300 of some embodiments. In this example, the establishments 210 are grouped into a single establishment 210, a first set of establishments 310, and a second set of establishments 320.

In some embodiments, establishments 210 may be included in multiple groups or sets (e.g., a first group may include retailers that sell a first product while a second group may include retailers that sell a second product, where some retailers sell both products).

A set of establishments may be associated based on various applicable criteria. For instance, establishments associated with a chain may be grouped together. As another example, types of establishments may be grouped together (e.g., grocery stores, clothing stores, etc.).

In some embodiments a single physical location (e.g., a department store, a mall, etc.) may be represented as a set 310 of establishments 210, where each establishment in the set 310 represents a section of the physical location (e.g., a department within the store, a store within the mall, etc.).

Different users may utilize different sets of establishments 210. For instance, a user associated with a retail chain may organize establishments representing each store in the chain by utilizing sets based on region, while a user associated with selling a product through that chain may be presented with a set of establishments where each retail chain is represented as a single establishment.

System 300 may allow content providers to efficiently distribute content and/or provide updates or commands to appropriate recipients.

The operation of system 300 will be described below in reference to FIGS. 5 and 7-9.

One of ordinary skill in the art will recognize that systems 100, 200, and 300 are conceptual in nature and different embodiments may be implemented in various different ways without departing from the scope of the disclosure. For instance, different embodiments may include different communication paths, may include additional elements, may omit some elements, etc.

### II. Methods Of Operation

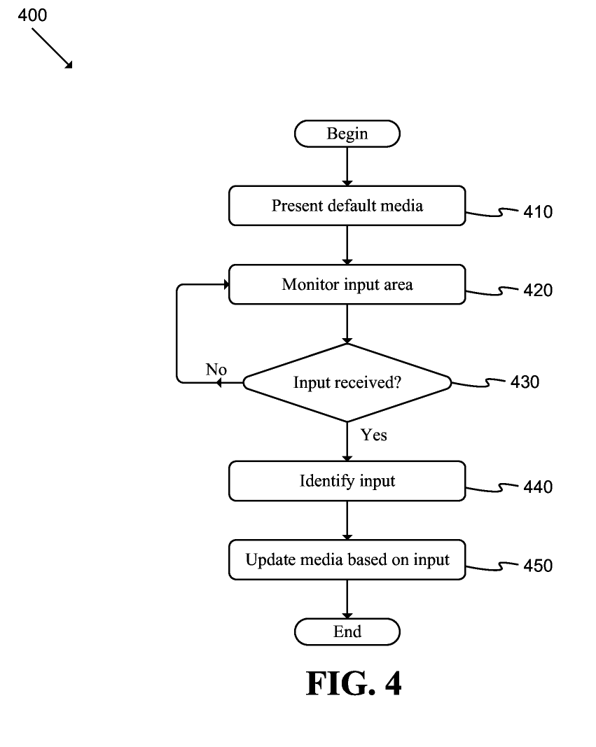

FIG. 4 illustrates a flow chart of a conceptual client-side process 400 used by some embodiments to provide an interactive consumer experience using a stand-alone interactive display. Such a display may be similar to display 110 described above. Process 400 may begin, for instance, when an interactive display is powered on.

As shown, the process may present (at 410) default media. Such media may include, for instance, a playlist of advertisements. Next, the process may monitor (at 420) a motion input area. Such an area may be similar to input range 140 described above.

The process may then determine (at 430) whether an input has been received. Such a determination may be made in various appropriate ways. For instance, the sensing element 120 of some embodiments may detect motion within the input area. If the process determines (at 430) that no input has been received, the process may repeat operations 420-430 until the process determines (at 430) that an input has been received.

If the process determines (at 430) that an input has been received, the process may then identify (at 440) the input. The input may be identified in various appropriate ways (e.g., by comparing captured motion to a look-up table of available commands). If the input cannot be identified, the process may provide an error message or otherwise indicate that the command was not recognized. In some cases, the process may provide visual or audio cues that indicate available command motions and/or actions.

After identifying (at 440) the input, the process may update (at 450) the presented media based at least partly on the input and then may end. For instance, the process may identify a hand-swipe motion, which causes the media to change from a first advertisement to a second advertisement. In some embodiments, the stand-alone display may be able to send content updates to other displays. Such updates may be based at least partly on the received input.

In some embodiments, the process may iteratively perform operations 420-450 until determining that the interactive session has ended (e.g., when the time since the last input was received exceeds a threshold). Once the process ends, the presented media may revert to the default media. For instance, the process may resume a rotation of clips before the detected motion or may otherwise revert to the default media (e.g., by going back in a playlist to play a clip that was skipped by a user).

In the example of process 400, an interactive display may be able to operate as a stand-alone unit that may not need or utilize network connectivity. In some embodiments, the display may receive media (and/or other updates) via a network, but the interactive control may be executed by the display without any communication with an external server or other controller.

FIG. 5 illustrates a flow chart of a conceptual client-side process 500 used by some embodiments to provide an interactive consumer experience using a network-connected interactive display. Such a display may be similar to display 110 described above. Process 500 may begin, for instance, when an interactive display is powered on.

As shown, the process may present (at 510) media. Such media may include, for instance, a playlist of advertisements. The playlist may be a default loop of clips (and/or display attributes) that is predefined by an authorized user.

Next, the process may monitor (at 520) a motion input area. Such an area may be similar to input range 140 described above.

The process may then determine (at 530) whether an input has been received. Such a determination may be made in various appropriate ways. For instance, the sensing element 120 of some embodiments may detect motion within the input area. If the process determines (at 530) that no input has been received, the process may repeat operations 520-530 until the process determines (at 530) that an input has been received.

If the process determines (at 530) that an input has been received, the process may then identify (at 540) the input. The input may be identified in various appropriate ways (e.g., by comparing captured motion data to a look-up table of available commands). If the input cannot be identified, the process may provide an error message or otherwise indicate that the command was not recognized. In some cases, the process may provide visual or audio cues that indicate available command motions and/or actions.

After identifying (at 540) the input, the process may send (at 550) a command associated with the input to the server. Alternatively, the process may send the received input directly to the server for analysis. Such a server may be similar to remote server 160 or local server 220 described above.

The server may then evaluate the received motion information (e.g., data captured by one or more cameras) to determine if a matching command may be identified at the server. Such data may be evaluated in various appropriate ways (e.g., by matching a motion to one of a set of available command motions in a look up table, by comparing a motion to a previously captured signature and determining whether the current and previous data match to within some threshold value(s), etc.). As above, if the motion is not recognized, the server may send an error message or other indication of non-recognition.

In some cases, the display and server may each perform portions of the analysis and identification of a command. For instance, a display may be able to identify only a particular set of motions without being aware of any associated commands. The display may identify a motion from the set of motions and send a message indicating the identification to the server. The server may, in turn, match the motion identification to a command, where such matching may consider other relevant factors than the motion identification (e.g., content displayed when the motion was performed, content currently available at the display, etc.). Of course, one of ordinary skill in the art will recognize that the various example operations may be performed by various appropriate divisions of tasks associated with motion recognition and/or command identification between a device and server.

Next, the process may receive (at 560) an update from the server. Such an update may be based at least partly on the received input. The update may include new media, a change to playlist order or other attributes, etc. In addition, the update may include termination criteria (e.g., elapsed time, receipt of a “resume” command, etc.)

Finally, the process may present (at 570) the updated media via the display and then may end. As above, in some embodiments, the process may iteratively perform operations 520-570 until determining that the interactive session has ended. Once the process ends, the interjected or updated media may revert to the default media. The interjected or overriding media may be presented for various durations and/or until various termination criteria are met. For instance, the overriding media may last for a specified amount of time, until a user stops interacting, etc.

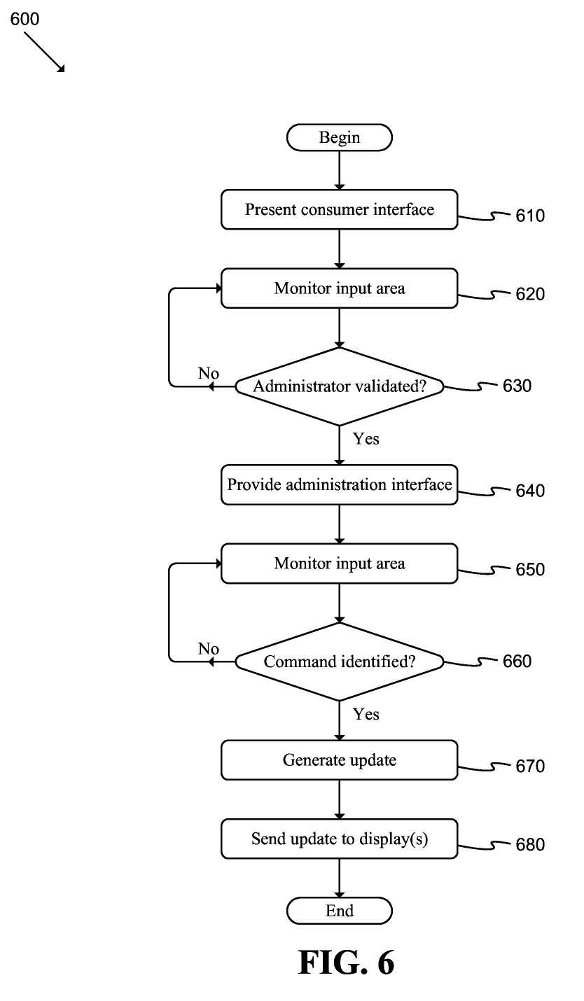

FIG. 6 illustrates a flow chart of a conceptual client-side process 600 used by some embodiments to provide administrative features using an interactive display such as display 110. Process 500 may begin, for instance, when an interactive display is powered on.

The process may present (at 610) a consumer interface. Such an interface may typically include a displayed advertisement (e.g., video, graphics, pictures, etc.). Next, the process may monitor (at 620) a motion input area. Such an area may be similar to input range 140 described above.

The process may then determine (at 630) whether an administrator has been validated. Such a determination may be made in various appropriate ways. For instance, some embodiments may require an administrator to perform a specific motion or sequence of motions to enter an administrator mode. For additional security, some embodiments may include other verification measures (e.g., detection of a wireless ID badge within a threshold distance of the display). In some embodiments, the specific motion or sequence of motions may be based on data associated with a specific user performing the motion (e.g., when a user is granted administrative privileges, the user may perform a set of movements that are used for future comparison).

If the process determines (at 630) that no administrator has been validated, the process may repeat operations 620-630 until the process determines (at 630) that an administrator has been validated.

If the process determines (at 630) that an administrator has been validated, the process may then provide (at 640) an administrator interface. Such an interface may include, for instance, a menu of options or commands, visual or audio cues, etc.

Next, the process may monitor (at 650) the motion input area. The process may then determine (at 660) whether a command has been identified. Such a determination may be made in various appropriate ways. For instance, the sensing element 120 of some embodiments may detect motion within the input area. If the process determines (at 660) that no command has been received, the process may repeat operations 650-660 until the process determines (at 660) that a command has been received.

If the process determines (at 660) that a command has been received, the process may generate (at 670) an update based on the received command. Such an update may include a change in media content, change in playlist attributes (e.g., order, number of repeats, etc.), and/or other appropriate updates.

The process may then send (at 680) the update to the display and then may end. In some embodiments, multiple displays may be connected locally (e.g., using a wireless connection, via cable connections, etc.). Thus, in some cases, the updates generated on a first display may also be sent to multiple other displays.

Operations 640-680 may be performed iteratively in some embodiments until the process determines that the administrative session has ended (e.g., based on receiving an “end session” motion command, based on a length of time passing since a last command was received, etc.).

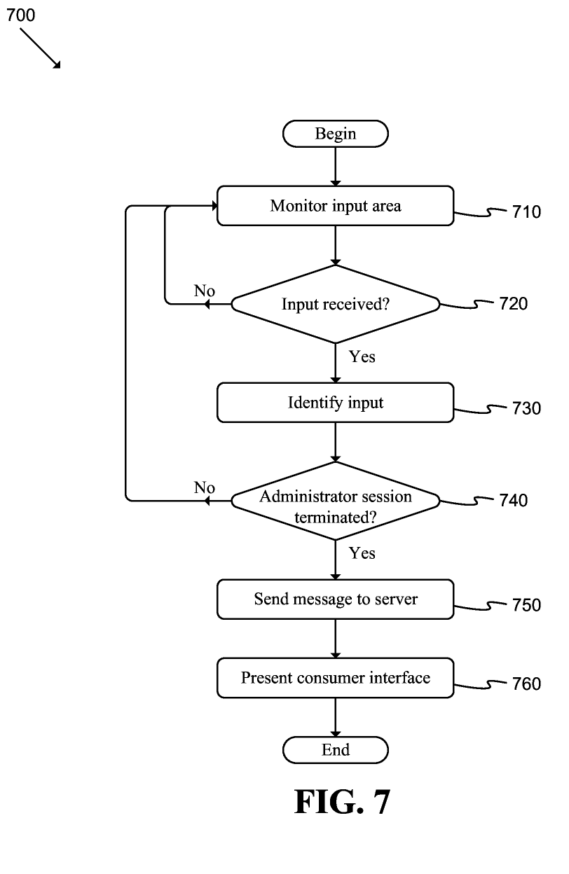

FIG. 7 illustrates a flow chart of a conceptual client-side process 700 used by some embodiments to provide administrative features using a network-connected interactive display such as display 110. The process may begin when an administrator has been validated (e.g., using operations similar to operations 610-640) described above.

Next, the process may monitor (at 710) the input area. The process may then determine (at 720) whether an input has been received. If the process determines (at 720) that no input has been received, the process may repeat operations 710-720 until the process determines (at 720) that an input has been received.

If the process determines (at 720) that an input has been received, the process may identify (at 730) the input. Next, the process may determine (at 740) whether the administrator session has ended. If the process determines (at 740) that the session has not ended, the process may repeat operations 710-740 until the process determines (at 740) that the session has ended.

If the process determines (at 740) that the session has ended, the process may then send (at 750) a message to the server based on the received input. Such a server may be similar to remote server 160 or local server 220 described above. The message may include updates to content, operating parameters, etc.

Next, the process may present (at 760) the consumer user interface and then may end. Subsequently, the server may provide updated content to a set of devices associated with the administrator using a process such as process 800 described below. Process 700 may allow the administrator to define the set of devices that will receive updated content.

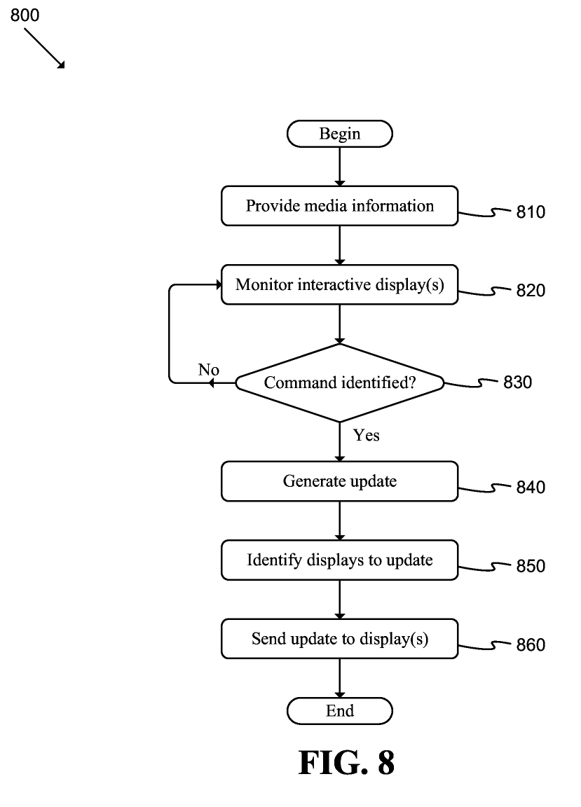

FIG. 8 illustrates a flow chart of a conceptual server-side process 800 used by some embodiments to provide media to a set of interactive displays such as display 110. Such a process may be executed by a server such as remote server 160 or local server 220 described above. The process may begin, for instance, when a server device is powered on.

As shown, the process may provide (at 810) media information (e.g., default media information) to the client devices. Such information may include, for instance, content, operating parameters, etc. The information may be provided over various appropriate pathways (e.g., local and/or remote networks). Such information may be updated at regular intervals, based on newly received content, etc.

Next, the process may monitor (at 820) the interactive displays. Such displays may be associated in various ways (e.g., displays within a physical establishment, displays associated with a brand, etc.). In some embodiments, the displays may be monitored by a local server or device that relays received information to a remote server or device.

The process may then determine (at 830) whether a command has been identified. Such a determination may be made in various appropriate ways (e.g., by determining whether a message has been received from a display, by determining that motion capture information received from a display is associated with a command, etc.). Such a command may include a consumer command received via a process such as process 500 or an administrative command received via a process such as process 600 or process 700. If an administrative command is received, the process may verify that the command was submitted by a validated administrator.

If process 800 determines (at 830) that no command has been identified, the process may repeat operations 820-830 until the process determines (at 830) that a command has been identified.

If the process determines (at 830) that a command has been identified, the process may then generate an update based on the received command. Such an update may include updates to content, playlist parameters, etc.

Next, the process may identify (at 850) the displays to update. The displays may be identified in various appropriate ways (e.g., using pre-defined groupings, based on administrator commands, etc.). Finally, the process may send (at 860) the update to the displays and then may end.

Alternatively, the process may revert to the media information before the update by sending another message or update. For instance, in some embodiments, an update may be related to a sale period or other special circumstance. Thus, the updated information may revert to the default after the special circumstance no longer exists (and/or based on some appropriate termination criteria).

One of ordinary skill in the art will recognize that processes 400, 500, 600, 700, and 800 may be implemented in various different ways without departing from the scope of the disclosure. For instance, different embodiments may perform the operations in a different order than shown, perform additional operations, and/or omit various operations. As another example, each process may be divided into a set of sub-processes and/or included as part of a larger macro-process. As still another example, various processes (or portions thereof) may be performed iteratively, at regular intervals, etc. In addition, several processes may be performed in parallel.

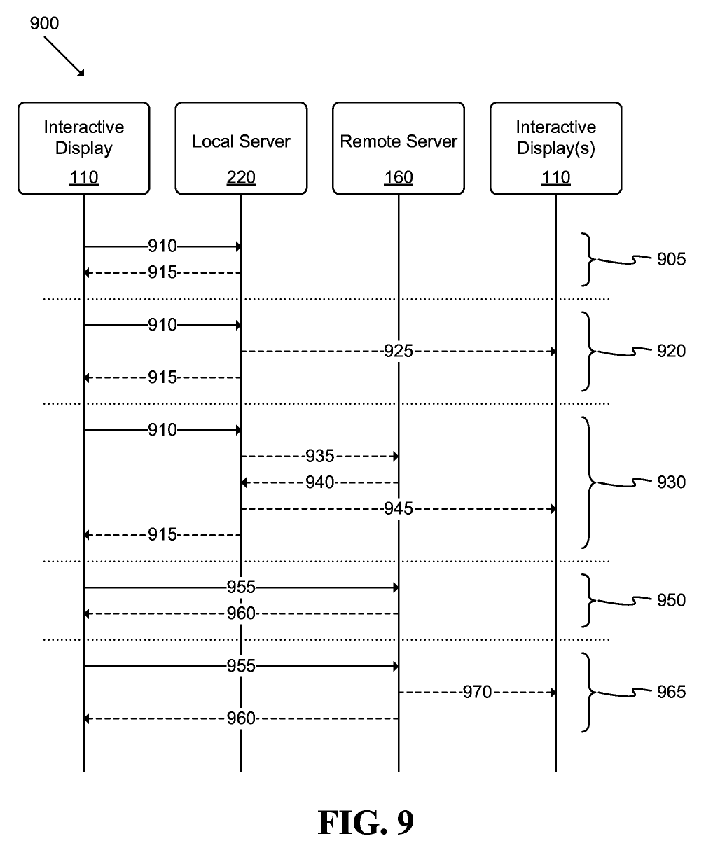

FIG. 9 illustrates a schematic block diagram of an exemplary communication procedure 900 used by some embodiments to provide an interactive experience. As shown, the procedure may be implemented using elements such as the interactive display 110, local server 160, and/or remote server 220 described above.

A first procedure 905 may be used to implement a process similar to process 500, process 700, or process 800, for example. As shown, the display 110 may send a message 910 to the local server 220. Such a message may include information related to a command received from a user such as a consumer or administrator.

In some embodiments, the local server 220 may simply collect data from the display 110 and no further action is taken. Alternatively, the local server 220 may send message 915 to the device 110. Message 915 may include information such as updated media, playlist parameters, termination criteria, etc.

A second procedure 920 may be used to implement a process similar to process 500, process 700, or process 800, for example. As shown, after receiving message 910, the local server may send a message 925 to other interactive displays 110 than the display that generated message 910. In this way, inputs received from a first display may be distributed to other displays (e.g., when an administrator updates content to be shown on multiple displays). In addition, a confirmation message 915 may be sent back to the interactive display 110 that generated message 910. Such a confirmation message may provide feedback to a user (e.g., an administrator) that a command was interpreted and/or applied as desired.

A third scheme 930 may be used to implement a process similar to process 500, process 700, or process 800, for example. As shown, local server 220 may, in response to message 910, send a message 935 to a remote server 160. Such a scenario may be used, for instance, when the displays 110 are not able to connect directly to the remote server 160. As shown, the remote server may send a reply 940. Such a reply may include, for instance, updated content. The local server 220 may then send an update message 945 to any associated displays 110. Finally, a confirmation message 915 may be sent back to the interactive display 110 that generated message 910.

A fourth procedure 950 may be used to implement a process similar to process 500, process 700, or process 800, for example. Such a procedure may be used when each display 110 is able to connect to the remote server 160. As shown, the display 110 may send a message 955 to the remote server 160. Such a message may include information related to a command received from a user such as a consumer or administrator. In some cases, the message 955 may include captured motion data for evaluation by the server 160.

In some embodiments, the remote server 160 may simply collect data from the display 110 and no further action is taken. Alternatively, the remote server 160 may send message 960 back to the device 110. Message 960 may include information such as updated media, playlist parameters, termination criteria, command identification, etc.

A fifth procedure 965 may be used to implement a process similar to process 500, process 700, or process 800, for example. As shown, remote server 160 may, in response to message 955, send an update message 970 to any associated displays 110. The update message 970 may include information such as media content, playlist updates, termination criteria, command identification, etc. Finally, a confirmation message 960 may be sent back to the interactive display 110 that generated message 955.

One of ordinary skill in the art will recognize that the communication procedure 900 is conceptual in nature and different embodiments may be implemented using various different procedure than those described above. For instance, some embodiments may send sets of multiple messages before receiving a response or causing any action to be taken by the receiving entity. As another example, some embodiments may send polling messages from the servers to initiate communication with any connected devices.

### III. Example Usage Scenarios

Several example scenarios are laid out below to illustrate various use cases of the resources provided by some embodiments. One of ordinary skill in the art will recognize that many other scenarios may be implemented.

A first example scenario includes a network of displays located at various places within a store. When a user interacts with a monitor, a game or other interactive task may be presented to the user. If the user completes or “wins” the game, the user may be provided with a coupon or other special offer. In addition, the other networked displays may have content pushed to them such that each display shows a message promoting the user's win and encouraging any viewers to also play the game.

In a second example scenario, a store manager may use a first display as an input terminal in order to push advertising related to sale items to all available displays (or displays located near the sale items, within a section of the store, to a single display, etc.). In some cases, the manager may add content related to a featured brand, for example, and remove advertisements associated with a competing brand.

In a third example scenario, a store manager may override a display playlist. The original playlist may include a list of video advertisements to play in succession. The store manager may use gestures to modify the playlist (e.g., adding clips, removing clips, etc.).

In a fourth example scenario, a user may encounter a display playing an advertisement that interests the user. The user may then interact with the display to receive more information related to the advertisement (e.g., product details, product location in store or establishment, related products, etc.). In some cases, the user may be able to drill down through a set of screens, each having different content and/or programming.

### IV. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be adapted to perform functions and/or features that may be associated with various software elements described throughout.

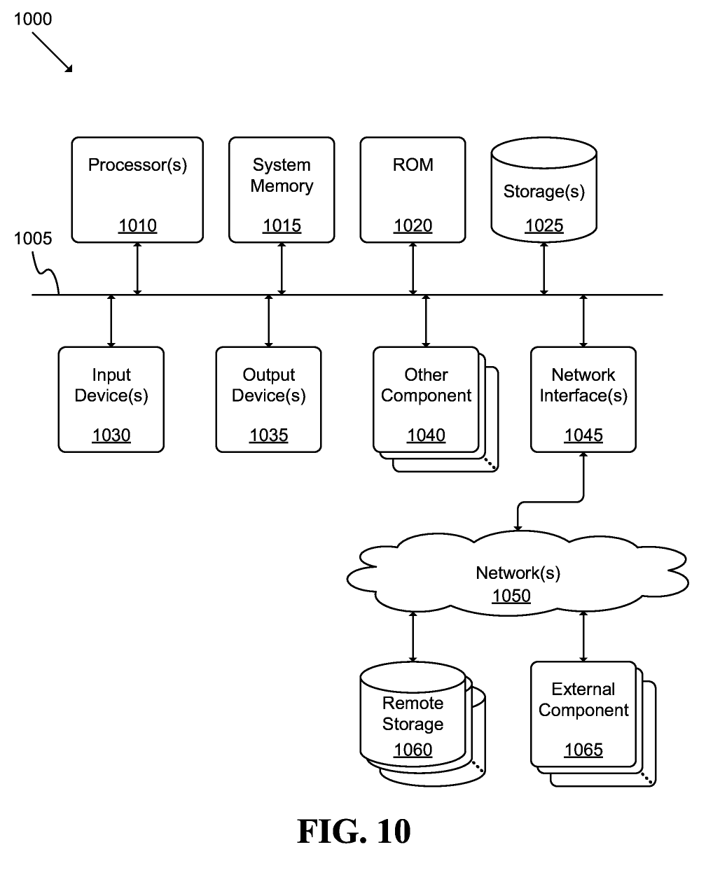

FIG. 10 illustrates a schematic block diagram of a conceptual computer system 1000 used to implement some embodiments. For example, an interactive display, motion sensing/gesturing device or elements, or local and/or remote servers may be implemented using one or more components of a computer system as described in FIG. 10. More specifically, the systems described above in reference to FIGS. 1-3 may be at least partially implemented using computer system 1000. As another example, the processes described in reference to FIGS. 4-8 may be at least partially implemented using sets of instructions that are executed using computer system 1000. As still another example, the communication procedure described in reference to FIG. 9 may be at least partially implemented using sets of instructions that are executed using computer system 1000.

Computer system 1000 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 1000 may include at least one communication bus 1005, one or more processors 1010, a system memory 1015, a read-only memory (ROM) 1020, permanent storage devices 1025, input devices 1030, output devices 1035, various other components 1040 (e.g., a graphics processing unit), and one or more network interfaces 1045.

Bus 1005 represents all communication pathways among the elements of computer system 1000. Such pathways may include wired, wireless, optical, and/or other appropriate communication pathways. For example, input devices 1030 and/or output devices 1035 may be coupled to the system 1000 using a wireless connection protocol or system.

The processor 1010 may, in order to execute the processes of some embodiments, retrieve instructions to execute and/or data to process from components such as system memory 1015, ROM 1020, and permanent storage device 1025. Such instructions and data may be passed over bus 1005.

System memory 1015 may be a volatile read-and-write memory, such as a random access memory (RAM). The system memory may store some of the instructions and data that the processor uses at runtime. The sets of instructions and/or data used to implement some embodiments may be stored in the system memory 1015, the permanent storage device 1025, and/or the read-only memory 1020. ROM 1020 may store static data and instructions that may be used by processor 1010 and/or other elements of the computer system.

Permanent storage device 1025 may be a read-and-write memory device. The permanent storage device may be a non-volatile memory unit that stores instructions and data even when computer system 1000 is off or unpowered. Computer system 1000 may use a removable storage device and/or a remote storage device as the permanent storage device.

Input devices 1030 may enable a user to communicate information to the computer system and/or manipulate various operations of the system. The input devices may include keyboards, cursor control devices, audio input devices and/or video input devices. Output devices 1035 may include printers, displays, and/or audio devices. Some or all of the input and/or output devices may be wirelessly or optically connected to the computer system.

Other components 1040 may perform various other functions. These functions may include performing specific functions (e.g., graphics processing, sound processing, etc.), providing storage, interfacing with external systems or components, etc.

Finally, as shown in FIG. 10, computer system 1000 may be coupled to one or more networks 1050 through one or more network interfaces 1045. For example, computer system 1000 may be coupled to a web server on the Internet such that a web browser executing on computer system 1000 may interact with the web server as a user interacts with an interface that operates in the web browser. Computer system 1000 may be able to access one or more remote storages 1060 and one or more external components 1065 through the network interface 1045 and network 1050. The network interface(s) 1045 may include one or more application programming interfaces (APIs) that may allow the computer system 1000 to access remote systems and/or storages and also may allow remote systems and/or storages to access computer system 1000 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 1000 may be used in conjunction with some embodiments. Moreover, one of ordinary skill in the art will appreciate that many other system configurations may also be used in conjunction with some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure. For example, several embodiments were described above by reference to particular features and/or components. However, one of ordinary skill in the art will realize that other embodiments might be implemented with other types of features and components, and that the disclosure is not to be limited by the foregoing illustrative details.

1-20. (canceled)

21. A method, comprising:
providing first content to be displayed on at least one display of a plurality of displays;
sensing a user input on the at least one display, wherein sensing the user input comprises detecting motion within an input area of the at least one display; and
updating the first content displayed on the at least one display of the plurality of displays based on the sensed user input.

22. The method of claim 1 further comprising:
comparing the sensed user input to a library of recognized inputs; and
providing an error message to the at least one display when the sensed input is not recognized.

23. The method of claim 1, wherein the update includes a termination criteria causing the first content to be redisplayed on one or more of the plurality of displays.

24. The method of claim 1, wherein the sensed user input is a hand gesture.

25. The method of claim 1, wherein the sensed user input is data captured by one or more cameras.

26. The method of claim 1, wherein at least one of the first content and the updated first content is advertising content.

27. A system, comprising:
a plurality of displays, each configured to display a first content and having an input area that senses a user input; and
a communication module coupled to a network and configured to update the first content displayed on at least one display of the plurality of displays in response to the sensed user input.

28. The system of claim 27, further comprising a processor configured to compare the sensed user input to a library of recognized inputs and provide an error message to be displayed on at least one display of the plurality of displays when the sensed input is not recognized.

29. The system of claim 27, wherein the update includes a termination criteria causing the first content to be redisplayed on at least one of the plurality of displays.

30. The system of clam 27, wherein the sensed user input is a hand gesture.

31. The system of claim 27, wherein the sensed user input is data captured by one or more cameras.

32. The system of claim 27, wherein at least one of the first content and the updated first content is advertising content.

33. The system of claim 27, wherein the communication module is any of a set top box, a mobile phone or a tablet device
